(19) United States
(12) Patent Application Publication
(10) Pub. No.: US 2022/0228562 A1
(43) Pub. Date: Jul. 21, 2022

(54) ENERGY STORAGE MECHANISMS FOR UNCONTROLLED FUEL INPUT TURBINE

(71) Applicants: Dishant MISHRA, Bareilly, Uttar Pardesh (IN); Samarth JAIN, Haryana (IN)

(72) Inventors: Dishant MISHRA, Bareilly, Uttar Pardesh (IN); Samarth JAIN, Haryana (IN)

(21) Appl. No.: 17/617,169

(22) PCT Filed: Jun. 8, 2020
(86) PCT No.: PCT/IN2020/050508

§ 371 Date: Dec. 7, 2021

(30) Foreign Application Priority Data
Jun. 7, 2019 (IN) 201911018173

(51) Int. Cl. F03D 9/16

(52) U.S. Cl. CPC F03D 9/16

(57) ABSTRACT

The invention relates to a system for controlling torque in a wind turbine. In one embodiment, the system includes a rotor, a rotor driveline coupled with the rotor and an electrical generator, the rotor driveline including a coupler, a torque control mechanism, a transmission system, the torque control mechanism comprising a variable torque converter, a switching mechanism and at least one energy storage system. During operation, the variable torque converter actuate the positive force and/or torque acting on rotor driveline in order to achieve the desired rpm when the set point of desired rpm is higher than the present value of the said rpm, and also to actuate the negative force and/or torque acting on the rotor driveline in order to achieve the desired rpm when the set point of desired rpm is lower than the present value of the said rpm.

### FIELD OF THE INVENTION

The subject matter described herein relates generally to wind turbines and, more particularly, the invention relates to the system and method for controlling operation of the turbines.

### BACKGROUND OF THE INVENTION

Wind turbine generators utilize wind energy to produce electrical power. Wind turbine generators typically include a rotor having multiple blades that transform wind energy into rotational motion of a drive shaft, which in turn is utilized to drive an electrical generator to produce electrical power.

Changes in atmospheric conditions, for example, wind speed, wind turbulence intensity, and wind direction, may significantly influence power produced by wind turbine generators. The power output of a wind turbine generator is proportional to the cube of wind speed until the wind speed reaches a ‘rated wind speed’ for the electrical generator runs at its maximum power output. Beyond rated wind speed, wind turbine blades are pitched to aerodynamically disallow a portion of energy above rated and thus, at and above the rated wind speed, the wind turbine generator operates at its maximum power.

Due to various constraints such as low capacity utilisation of the electrical system, It is not economically viable to design a turbine with a significantly large generator that can admit all the energy available in wind, as such a large amount of energy is allowed to forego in the current design.

Conventional solutions such as electrical battery storage cannot be deployed as it would require electrical power as input and thus large generator. Chemical storage like hydrogen synthesis etc. requires electrical power again poses similar shortcomings. Conventional flywheel storage occupies large space.

These conventional arts do not provide a reliable and consistent solution to effectively store large volumes of energy in short range while there is a significant gap between powers available to electrical generator capacity. The conventional attempts have not been able to reduce the inefficiencies and difficulties inherent in using wind as a more efficient and consistent source for energy.

Notwithstanding these problems, as wind is a significant natural resource that will never run out, and is available in abundance in many geographies, there is a need to try to develop a long term storage system that can increase throughput of power available in wind to electrical power output, to increase the overall electrical output of the turbine, an intermediate energy storage system at mechanical level, which may capture and store such large energy before the electrical generator, may be designed to increase the overall throughput and thus the output of the turbine.

Therefore, there is a need for a method and system which can effectively increase the power output in a wind turbine that can solve above mentioned problems.

### SUMMARY OF THE INVENTION

An aspect of the present invention is to address at least the above-mentioned problems and/or disadvantages and to provide at least the advantages described below.

Accordingly, in one aspect of the present invention provides a system for

Controlling torque in a wind turbine. In one embodiment, the system includes a rotor, the axis of rotation extending longitudinally through said rotor, a plurality of blades mounted to the rotor to drive the rotor in response to an airflow and a rotor driveline coupled with the rotor and an electrical generator, the rotor driveline including a coupler, a torque control mechanism, a transmission system, the torque control mechanism comprising a variable torque converter, a switching mechanism and at least one energy storage system. During operation, the rotor driveline receives input from the rotor as an aerodynamic or mechanical energy source by means of varying the force transmitted and/or moment arm of the bodices, transmitting the said force, between the rotor driveline and the energy Storage system to make kinetic energy system reach and maintain the desired rotor and/or generator rpm. The variable torque converter actuate the positive force and/or torque acting on rotor driveline in order to achieve the desired rpm when the set point of desired rpm is higher than the present value of the said rpm, and also to actuate the negative force and/or torque acting on the rotor driveline in order to achieve the desired rpm when the set point of desired rpm is lower than the present value of the said rpm/And, the energy storage system converts some of the kinetic energy from the said rotor driveline into stored potential or kinetic energy in the said energy storage system and, [further converts/utilizes the stored energy in the said energy storage system into Kinetic energy of the said rotor driveline, so as to provide the said rotor driveline the amount of positive or negative force required to achieve the said desired rpm.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:.

FIG. 1 illustrates a block diagram of the system showing the flow of energy in the Kinetic energy system [rom the rotor to the generator, according to one embodiment of the present invention;

FIG. 2 is a schematic diagram of an energy storage system, according to one embodiment of the present invention;

FIG. 3 illustrates a kinetic energy system, according to one embodiment of the present invention;

FIG. 4 illustrates the switching mechanism, according to one embodiment of the present invention;

FIG. 5 illustrates the switching mechanism in detail, according to one embodiment of the present invention;

FIG. 6 illustrates an energy storage system based upon energy storage in the form of pressurised fluid according to one example embodiment of the present invention;

FIG. 7 illustrates an energy storage system based upon gravitational potential energy, according to one example embodiment of the present invention;

FIG. 8 illustrates an energy storage system based upon kinetic energy storage system, according to one example embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

To facilitate understanding, like reference numerals have been used, where possible, to designate like elements common to the figures.

### DETAILED DESCRIPTION OF THE PREFERRED EMBODIMENTS

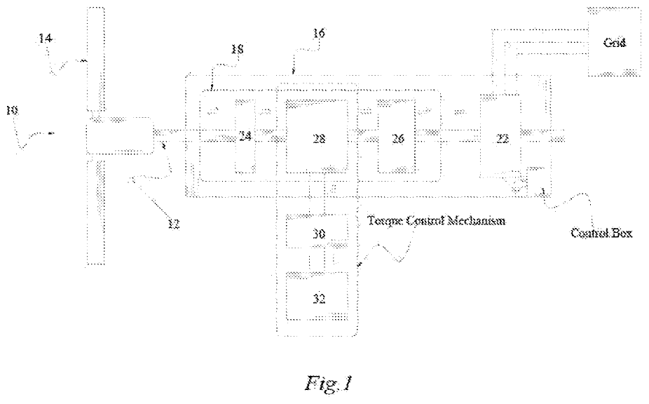

FIG. 1 shows a system (10) operable to generate electric power is provided. The wind turbine system (10) comprises a rotor (12) having multiple blades (14). The wind turbine system (10) also comprises a nacelle (16) that is mounted atop a tower. The rotor (12) is drivingly coupled to components over the rotor driveline (18) of the wind turbine system (10) housed within the nacelle (16). The tower exposes the blades (14) to the wind, which causes the blades (14) to rotate about an axis (20). The blades (14) convert the mechanical energy of the wind into a rotational torque, which is further converted into electrical energy by the wind turbine system (10). In the present system, the rotor driveline (18) is coupled with the rotor (12) and an electrical generator (22), the rotor driveline (18) including a coupler (24),wherein the coupler (24) is there to decouple or vary the strength of its coupling between rotor and generator, so as to make the rotor operate at max efficiency in wind speeds beyond rated and to make the said generator extract stored energy from the said energy storage system at maximum efficiency when wind speeds are below rated, a torque control mechanism, and a transmission system (26). The torque control mechanism comprising a variable torque converter (28), a switching mechanism (30) and at least one energy storage system (32). More specifically, the FIG. 1 shows the flow of energy in the Kinetic energy system from the rotor to the generator, wherein an energy storage system is coupled in between the said Kinetic energy system and generator, through a number of components, and is placed to actuate. The torque acting on the rotor driveline in order to achieve the said desired rpm of rotor or generator or both. Further, the electrical generator may be further connected to a power grid through a connection (such as slip-ring) to supply or consume power to or from the main generator or power grid. The wind turbine of FIG.1 is an uncontrolled fuel, or input energy, input turbine i.e. turbine in which the fuel input such as wind may not be controlled or whose amount may be predicted. Tidal turbines are other such turbines that rely on fuel that cannot be controlled or whose input fuel's amount may be predicted.

In an example operation of the system, the rotor driveline receives input from the rotor as an aerodynamic or mechanical energy source by means of varying the [force transmitted and/or moment arm of the bodies, transmitting the said force, between the rotor driveline and the energy storage system to make kinetic energy system reach and maintain the desired rotor and/or generator rpm. The variable torque converter actuate the positive force and/or torque acting on rotor driveline in order to achieve the desired rpm when the set point of desired rpm is higher than the present value of the said rpm, and also to actuate the negative force and/or torque acting on the rotor driveline in order to achieve the desired rpm when the set point of desired rpm is lower than the present value of the said rpm. The coupling between the rotor driveline and sub-systems presented here may be fluid coupling or an attractive and/or repulsive force field coupling, tension or rigid member or friction coupling or a combination of or hybrid of any of the above couplings. Further, the energy storage system converts some of the kinetic energy from the said rotor driveline into stored potential or kinetic energy in the said energy storage system and, further converts/utilizes the stored energy in the said energy storage system into Kinetic energy of the said rotor driveline, so as to provide the said rotor driveline the amount of positive or negative force required to achieve the said desired rpm.

The effective diameter ratio between the rotor driveline and generator and/or rotor driveline and rotor can be actuated in order to actuate the positive or negative torque provided to the said rotor and/or generator. Effective diameter ratio in the presented mechanism is defined as the product of ratio of diameter of all pair/s of the adjacent rotating bodies coupled to each other starting from the rotary body attached to the said first system/subsystem to the rotary body attached to the said second system/subsystem, wherein the effective diameter ratio is directly proportional to the multiplication of torque from the said first system/subsystem to the second system/subsystem.

The torque supplying mechanism 1.e. rotor and the rotor driveline and other means forming a subsystems which is capable of providing negative and/or positive torque to the turbine in the direction of rotation of the turbine so as to make the turbine reach and operate at desired rpm. The desired rpm can be the rpm of the said turbine rotor and/or the said main electrical generator calculated by the controller/s to enable maximum (possible) efficiency of conversion of energy between input and output of said kinetic energy system. While the desired rpm are the rpm of the rotor or generator, computed such that to extract maximum energy from the available input kinetic energy and convert it into rotational kinetic energy of the said kinetic energy system and further to elongate the duration of turbine maximum efficiency operations, provide sufficiently enough instantaneous power required by the grid protocols, handling peak load, power demand supply balancing, rotor and/or generator over speeding, electrical fault, network fault & system failure, electrical safety, positive reserve, negative reserve, transient, dynamic and steady state stability in grid's frequency/wind farm power output, critical vibration dampening in different vibrational modes, Mechanical load rationalization of turbine major components, wake compensation.

The said coupling system has at least two states of operations, while the first mode is the coupled state, in the coupled state the energy storage system is coupled to rotor driveline through variable force converter mechanism and the second state is the decoupled state which the energy storage system is decoupled from the rotor driveline, wherein the force transmitted between the rotor driveline and energy storage system can be varied by varying the strength of the couplings, by varying either the moment arm or torque distribution, between the rotor driveline and the said energy storage system and force provided by the said energy storage system respectively.

The torque supplying mechanism, may also be referred as torque control mechanism, includes of at least one switching mechanism, wherein the switching mechanism switches the direction of rotation and or translation of the rotary or translating body or fluid, connected to the said energy storage system at one point and the said rotor driveline at another point, so as to deliver both positive or negative torque by the said energy storage system in the same direction as of the direction of rotation of the said rotor driveline, coupled to rotor and/or generator

The variable torque converter has (at least) two modes of operation, wherein the said variable torque converter operates in first mode to actuate the positive force acting on turbine rotor driveline in order for turbine rotor driveline to achieve the desired rpm when the set point of desired rpm is higher than the present value of the said rpm, the said variable torque converter operates in second direction to actuate the negative force acting on the turbine rotor driveline in order for turbine rotor driveline to achieve the desired rpm when the set point of desired rpm is lower than the present value of the said rpm.

The said rotor driveline consist of at least one transmission system, wherein the transmission system shifts through a range of effective speed-torque ratios, so as to make the rotor operate at max efficiency in wind speeds beyond rated and to make the said generator extract stored energy from the said energy storage system al maximum efficiency when wind speeds are below rated.

The energy storage system may be kinetic energy storage system that is based upon energy possessed by a system when the said rotary and/or translating body or fluid is in motion or may be a Potential energy storage system where the energy is stored by the virtue of an object's position in an external force field such as gravitational field or magnetic field etc. and is hence referred to as potential energy stored in the form of gravitational potential energy storage and magnetic potential energy storage respectively. In an example embodiment, the said energy storage system may comprise of at least one Potential energy storage system that operates in two modes; wherein in First mode of operation converts potential of the said forms into Kinetic energy of rotor driveline, the second mode of operation converts kinetic energy of the said rotor driveline into the potential energy of the said forms by the said means, so as to provide the said rotor driveline the amount of positive or negative force required to achieve the said desired rpm. Further, the said energy storage system may be a kinetic energy storage system that comprises of at least one rotary and/or linearly translating body and/or fluid referred to as ‘kinetic energy storage member’ coupled to the rotor driveline through at least one variable torque converter. The said kinetic energy storage system is coupled to variable force converter through at least one coupling such as tension member coupling, rigid body coupling or fluid coupling, force field coupling or combination of any of the above couplings, wherein the said kinetic energy storage member is capable of gaining kinetic energy by gaining velocity in rotational and/or linear and/or oscillating motion or a combination of such motions.

Further, in an example embodiment, the said Kinetic energy storage system operate in two modes; wherein first mode of operation converts kinetic energy of the said rotor driveline into the Kinetic energy of the said kinetic energy storage member and while in the second mode of operation converts kinetic energy of at least one of the said kinetic energy storage member into Kinetic energy of the said rotor driveline so as to provide the said rotor driveline the amount of positive or negative force required to achieve the said desired rpm.

Further the said system (10) may include an additional electrical generator in series or parallel with potential energy and kinetic energy storage system in order to increase the energy storage capacity and/or torque control range of the said energy storage system.

Further the said system (10) may comprise of an additional energy extracting and storage mechanism as a heat exchanger or transducer, coupled to the said system (10), in order to increase the efficiency of the presented system.

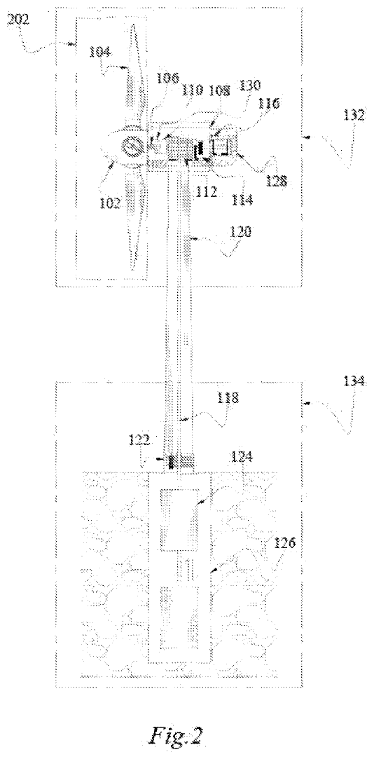

FIG. 2 is a schematic diagram of energy storage system (134) with energy storage system/means (124) mounted inside a housing (126), the said energy storage system (134) is further coupled to a switching mechanism (122) via a tension member (118) And a kinetic energy system (132) through a variable torque converter (112), consisting of rotor (202) comprising of blades (104) connected to the hub (102), which is further coupled, via coupling (110), to rotor driveline (130) comprising of a rotor shaft (106), wherein the said rotor shaft (106) is connected to generator (116) via a transmission system (114), further the said variable torque converter (112) is coupled to the rotor driveline via clutch (108), wherein the said rotor driveline and generator are mounted on the tower (120) , further the system comprises of a controller (128), wherein the said energy storage system (134) when coupled, through variable torque converter (112), to the kinetic energy system(132) provides required positive or negative torque to the kinetic energy system (132) through the said subsystems in order to achieve the said desired rpm of rotor (202) or generator (114) or both.

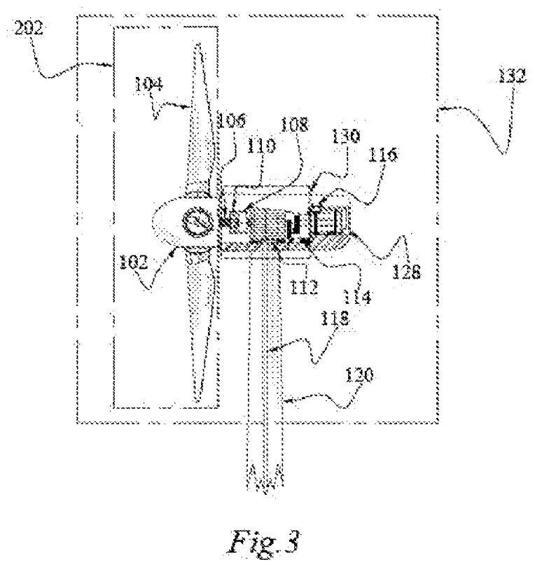

FIG. 3 illustrates kinetic energy system (132) which consists of blades (104) connected to the hub (102) which is further coupled, via coupling (110), to rotor driveline (130) consisting of a rotor shaft (106), coupled to the variable torque converter (112) through a clutch (108), wherein the said rotor driveline (130) is further coupled to the generator (116) through a transmission system (114).

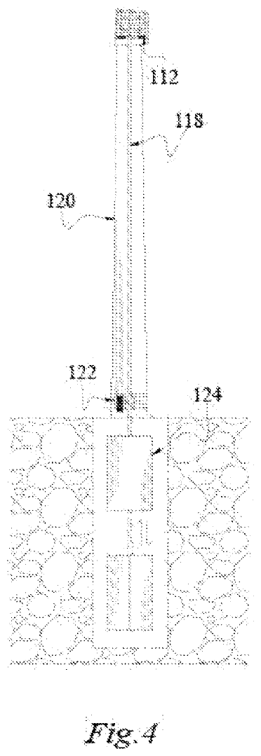

FIG. 4 illustrates switching mechanism (122) coupled to variable torque converter on one point (112) and energy storage system on another point (124) respectively, through tension member (118).

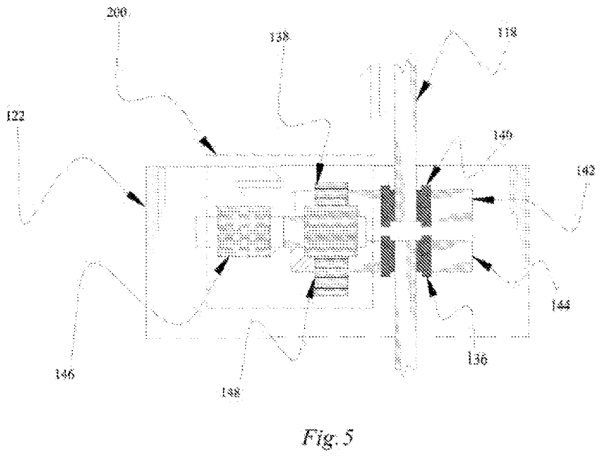

FIG. 5 illustrates switching mechanism (122) consisting of first pulley (140) and second pulley (136) mounted on first shaft (142) and second shaft (144) respectively, coupled via a gear arrangement (200), comprising of first gear (138) and second gear (148) and an idler gear (146), wherein the idler gear is configured to slide in between and slide out of the first and second gear in order to make the direction in which the first and second gear are moving same or opposite respectively.

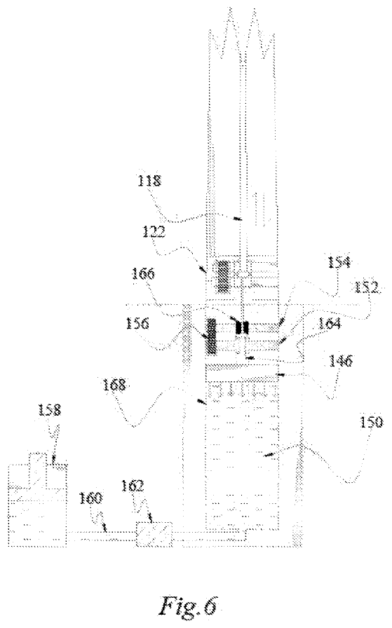

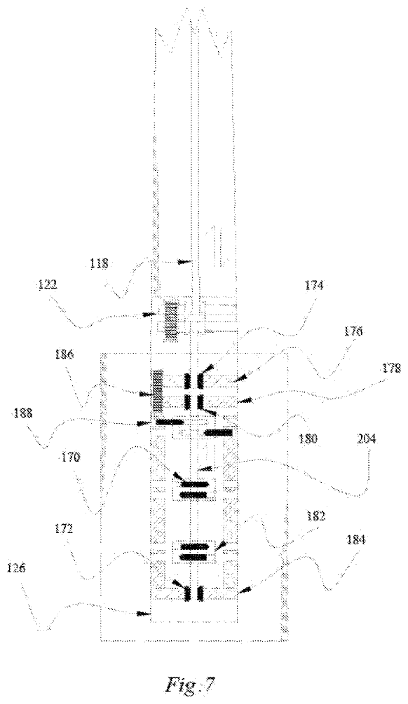

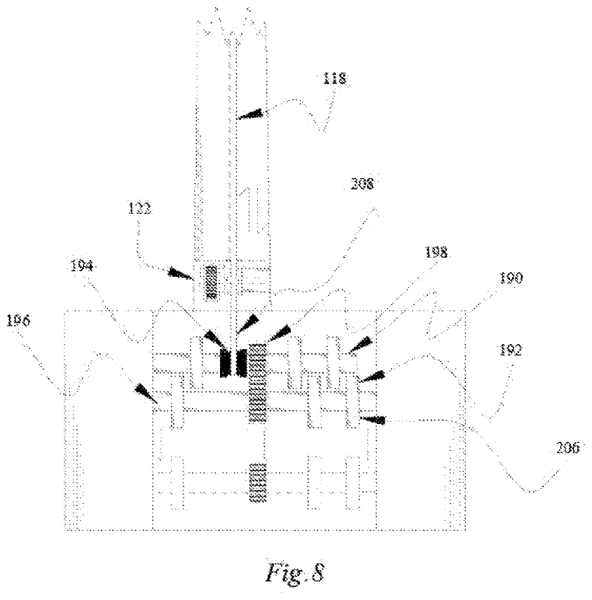

The energy storage system consists of various energy storage system as described in FIG. 6, FIG. 7, FIG. 8.

FIG. 6 illustrates energy storage system based upon energy storage in the form of pressurised fluid consisting of a piston (146) inside a pressure vessel (168) with fluid (150), with piston (146) coupled to the crankshaft (152) via connecting rod (164), along with a first shaft (154) connected to the crankshaft (152) via gear coupling (156). The first shaft (154) is further coupled to the switching mechanism (122) with a pulley (166) mounted on the first shaft (154) via tension member (118). Pressure vessel (168) is further connected to the compressor (158) via pipeline (160) with a flow control valve (162). In an embodiment of the present invention, the piston (146) is configured to pressurise and depressurise the said fluid (150) hence providing the desired amount of said positive or negative torque to the said kinetic energy system (132).

FIG. 7 illustrates a storage system based upon gravitational potential energy, according to one example embodiment of the present invention. The system consisting of column (188) with mass (182) coupled to a positive drive belt (204) via locking pins (170), with positive drive belt (204) coupled in open belt drive arrangement through driving pulley (178) and driven pulley (180) mounted on the second shaft (178) and third shaft (184) respectively. The second shaft (178) is further coupled to the first shaft (176) via gear coupling (186), wherein the first shaft is further coupled with the switching mechanism (122). In an embodiment, the said mass (182) are configured to move in the direction and against the direction of the gravitational field in the said housing (126) to store and release the desired amount of gravitational potential energy in the said mass (182), further the said locking pins (170), by sliding into and out of the cavities in the said column (188); and simultaneously sliding out of and into cavities in the said positive drive belt (204), couples the said mass (182) with column (188) and positive drive belt (204), respectively, controls the amount of mass (182) translating on the positive drive belt (204) at any instance.

FIG. 8 illustrates storage based upon kinetic energy storage system consisting of first flywheel system (192) and second flywheel system (206) mounted on the primary shaft (190) and the secondary shaft (196) coupled via gear coupling (198), further a pulley (194) mounted on the primary shaft (190) is coupled to the switching mechanism (122) through second tension member (208). In an embodiment, the said secondary shaft (196) is configured to move so as to couple-decouple the said second flywheel system (206) from primary shaft (190), in order to actuate the positive and negative torque provided by the kinetic energy storage system to the said kinetic energy system (132).

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this detailed description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for controlling torque in a wind turbine, the system comprising:
a rotor, the axis of rotation extending longitudinally through said rotor;
a plurality of blades mounted to the rotor to drive the rotor in response to an airflow; and
a rotor driveline coupled with the rotor and an electrical generator, the rotor driveline including a coupler, a torque control mechanism, a transmission system, the torque control mechanism comprising a variable torque converter, a switching mechanism and at least one energy storage system,
wherein, during operation, the rotor driveline receives input from the rotor as an aerodynamic or mechanical energy source by means of varying the force transmitted and/or moment arm of the bodies, transmitting the said force, between the rotor driveline and the energy storage system to make kinetic energy system reach and maintain the desired rotor and/or generator rpm,
wherein the variable torque converter actuate the positive force and/or torque acting on rotor driveline in order to achieve the desired rpm when the set point of desired rpm is higher than the present value of the said rpm, and also to actuate the negative force and/or torque acting on the rotor driveline in order to achieve the desired rpm when the set point of desired rpm is lower than the present value of the said rpm, and
wherein the energy storage system converts some of the kinetic energy from the said rotor driveline into stored potential or kinetic energy in the said energy storage system and, further converts/utilizes the stored energy in the said energy storage system into Kinetic energy of the said rotor driveline, so as to provide the said rotor driveline the amount of positive or negative force required to achieve the said desired rpm.

2. The system of claim 1, wherein the switching mechanism switches the direction of rotation and or translation of the rotary or translating body or fluid, connected to the said energy storage system at one point and the said rotor driveline at another point, so as to deliver both positive or negative torque by the said energy storage system in the same direction as of the direction of rotation of the said rotor driveline, coupled to rotor and/or generator.

3. The system of claim 1, wherein the desired rpm is the rpm of the rotor or generator, computed by a controller of the variable torque converter to extract maximum energy from the available input kinetic energy, in the wind, and convert it into rotational kinetic energy of the said kinetic energy system.

4. The system of claim 1, wherein the energy storage system is a potential and/or kinetic energy storage system which stores the energy in the potential or kinetic form.

5. The system of claim 1, wherein the force transmitted between the rotor driveline and energy storage system is varied by varying the strength of the couplings between the rotor driveline and the said energy storage system and force provided by the said energy storage system respectively.

6. The system of claim 1, wherein the transmission system shifts through a range of effective speed-torque ratios, so as to make the rotor operate at max efficiency in wind speeds beyond rated and to make the said generator extract stored energy from the said energy storage system at maximum efficiency when wind speeds are below rated.

7. The system of claim 1, wherein, the coupler to decouple or vary the strength of its coupling between rotor and generator, so as to make the rotor operate at max efficiency in wind speeds beyond rated and to make the said generator extract stored energy from the said energy storage system at maximum efficiency when wind speeds are below rated.

8. The system of claim 1, wherein, the said Kinetic energy storage system comprises of at least one kinetic energy storage member coupled to the rotor driveline through at least one variable torque converter, wherein the said kinetic energy storage member is capable of gaining kinetic energy by gaining velocity in rotational and/or linear and/or oscillating motion or a combination of such motions.

9. The system of claim 1, wherein the energy storage system based upon gravitational potential energy to store and release the desired amount of gravitational potential energy.

10. The system of claim 1, wherein the energy storage system is in the form of pressurised fluid to provide the desired amount of said positive or negative torque to the said kinetic energy system.

11. The system of claim 1, wherein the energy storage system is based upon kinetic energy storage system in order to actuate the positive and negative torque provided by the kinetic energy storage system to the said kinetic energy system.

12. An energy storage system in a turbine system, the system comprising:
a rotor, the axis of rotation extending longitudinally through said rotor;
a plurality of blades mounted to the rotor to drive the rotor in response to an airflow; and
a rotor driveline coupled with the rotor and an electrical generator, the rotor driveline including a coupler, a torque control mechanism, a transmission system, the torque control mechanism comprising a variable torque converter, a switching mechanism and at least one energy storage system,
wherein, during operation, the rotor driveline receives input from the rotor as an aerodynamic or mechanical energy source by means of varying the force trans milled and/or moment arm of the bodies, transmitting the said force, between the rotor driveline and the energy storage system to make kinetic energy system reach and maintain the desired rotor and/or generator rpm,
wherein the variable torque converter actuate the positive force and/or torque acting on rotor driveline in order to achieve the desired rpm, and
wherein the energy storage system stores the energy based upon gravitational potential energy, the energy storage system comprising of column with mass coupled to a positive drive belt via locking pins, with positive drive belt coupled in open belt drive arrangement through driving pulley and driven pulley mounted on the second shaft and third shaft respectively, the second shaft is further coupled to the first shaft via gear coupling, wherein the first shaft is further coupled with the switching mechanism, and wherein the said mass are configured to move in the direction and against the direction of the gravitational field in the said housing to store and release the desired amount of gravitational potential energy in the said mass, further the said locking pins, by sliding into and out of the cavities in the said column, and simultaneously sliding out of and into cavities in the said positive drive belt, couples the said mass with column and positive drive belt, respectively, controls the amount of mass translating on the positive drive belt.

13. The energy storage system of claim 12, further comprising:
wherein the energy storage system stores the energy in the form of pressurised fluid, the energy storage system comprising a piston inside a pressure vessel with fluid, the piston coupled to a crankshaft via a connecting rod, along with a first shaft which is connected to the crankshaft via gear coupling, the first shaft is further coupled to the switching mechanism with a pulley mounted on the first shaft via tension member, a pressure vessel is further connected to the compressor via pipeline with a flow control valve, wherein the piston is configured to pressurise and depressurise the said fluid thereby providing the desired amount of said positive or negative torque to the said kinetic energy system.

14. The energy storage system of claim 12, further comprising:
wherein the energy storage system is based upon kinetic energy storage system, the energy storage system comprising of first flywheel system and a second flywheel system mounted on the primary shaft and the secondary shaft coupled via gear coupling, further includes a pulley mounted on the primary shaft which is coupled to the switching mechanism through second tension member, wherein the said secondary shaft is configured to move so as to couple-decouple the said second flywheel system from primary shaft, in order to actuate the positive and negative torque provided by the kinetic energy storage system to the said kinetic energy system.

15. The system of claim 1, the combination or hybrid of the said energy storage systems can be coupled to multiple turbines in a power generation plant.

16. The system of claim 1, further includes an additional electrical generator in series or parallel with Potential Energy and Kinetic energy storage system in order to increase its energy storage capacity and/or torque control range.

17. The system of claim 1, further comprising:
an additional energy extracting and storage mechanism as a heat exchanger or transducer in order to increase the efficiency of the presented system.
